(19) United States
(12) Patent Application Publication
(10) Pub. No.: US 2010/0077009 A1
(43) Pub. Date: Mar. 25, 2010

(54) CONTENTS PLAYING APPARATUS AND CONTROL METHOD THEREOF

(75) Inventor: Won-gyu PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/490,475

(22) Filed: Jun. 24, 2009

(30) Foreign Application Priority Data
Sep. 10, 2008 (KR) 10-2008-0089380

(51) Int. Cl. G06F 17/30

(52) U.S. Cl. 707/802; 707/E17.014

(57) ABSTRACT

Provided are a contents playing apparatus and a control method thereof, in which the contents playing apparatus includes: a connection unit to which an external device is connected; a storage unit; and a controller which, if the external device is connected through the connection unit, automatically searches for contents stored in the external device in a search, and stores each of the found contents in the storage unit. With this, it is convenient for a user to store the contents in the contents playing apparatus from the external device.

### CROSS-REFERENCE TO RELATED APPLICATION

This application claims priority from Korean Patent Application No. 10-2008-0089380, filed on Sep. 10, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a contents playing apparatus and a control method thereof.

2. Description of the Related Art

Recently, many electronic devices which play various contents have been launched. As used herein, “contents” includes video, audio and/or image data. Typically, if an external device which stores contents therein is connected to a playing apparatus, the playing apparatus provides information about the connection of the external device to a user. However, to store such contents from the external device in the playing apparatus, a user should perform an operation to select the storing of the contents, and the playing apparatus should include an interface to support such operation. If the playing apparatus does not include such intermediate interface, a user may inconveniently download the contents by using other media such as a computer.

### SUMMARY OF THE INVENTION

The present invention provides a contents playing apparatus including: a connection unit to which an external device is connected; a storage unit; and a controller which automatically searches for contents stored in the external device and stores the searched contents in the storage unit if the external device is connected through the connection unit.

The controller may automatically store the contents in the storage unit if the external device is connected.

The controller may automatically generate a folder to store contents therein if the external device is connected.

The controller may automatically generate the folder according to a generation date of the contents and store the contents in the folder corresponding to the generation date thereof.

The controller may automatically generate a name of the folder with the generation date of the contents.

The folder may be automatically generated by using additional information stored together with the contents if the contents include image data.

The controller may automatically generate a name of the folder with the additional information used for generating the folder.

The controller may automatically generate the folder according to a type of contents, store the contents in the folder corresponding to the type of contents thereof and generate a name of the folder with the type of the contents.

The controller may automatically generate the folder according to a storing date of the contents and store the contents in the folder corresponding to the storing date thereof.

The controller may automatically generate a name of the folder with a storing date of the contents.

The contents playing apparatus may further include a display unit which displays an image thereon, wherein, if the contents include image data, the controller adjusts a resolution of the contents based on a resolution of the display unit, and stores the contents whose resolution is adjusted.

The controller may display a remaining capacity of the storage unit after the contents are stored.

The controller may display a current contents storage capacity versus a total capacity of the storage unit after the contents are stored.

Further, the present invention provides a control method of a contents playing apparatus which includes a storage unit, the control method including: searching contents which are stored in an external device if the external device is connected to the contents playing apparatus; and automatically storing the searched contents in the storage unit.

### BRIEF DESCRIPTION OF THE DRAWINGS

The above and/or other features of the present invention will become apparent and more readily appreciated from the following description of the exemplary embodiments, taken in conjunction with the accompanying drawings of which:

FIG. 1 is a control block diagram of a contents playing apparatus according to an exemplary embodiment of the present invention;

FIGS. 2A to 2C illustrate types of folders generated by a contents playing apparatus according to another exemplary embodiment of the present invention;

FIG. 3 is a control flowchart illustrating a control method of the contents playing apparatus according to another exemplary embodiment of the present invention;

FIG. 4 illustrates a contents playing apparatus according to another exemplary embodiment of the present invention; and

FIG. 5 is a control flowchart illustrate a control method of the contents playing apparatus in FIG. 4.

### DETAILED DESCRIPTION OF EXEMPLARY EMBODIMENT

Hereinafter, exemplary embodiments of the present invention will be described with reference to accompanying drawings, wherein like numerals refer to like elements and repetitive descriptions will be avoided as necessary.

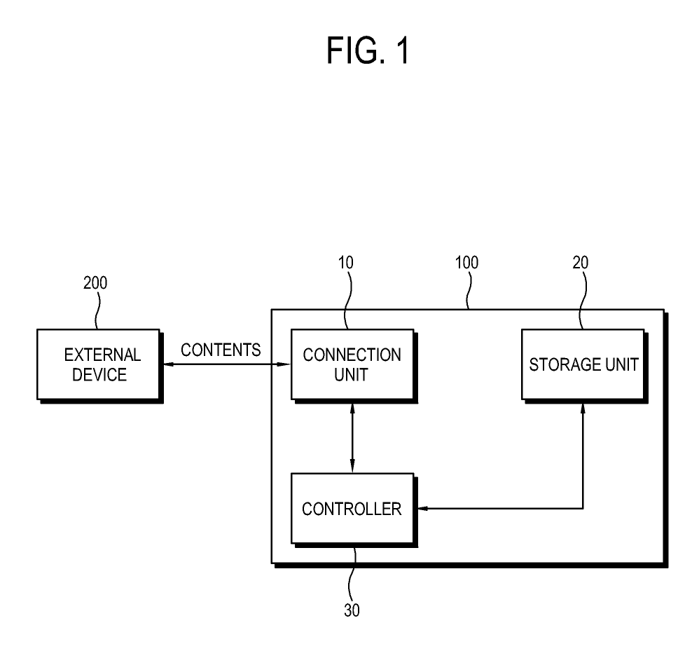

FIG. 1 is a control block diagram of a contents playing apparatus according to an exemplary embodiment of the present invention.

As shown therein, a contents playing apparatus 100 includes a connection unit 10 to which an external device 200 is connected, a storage unit 20 and a controller 30 which controls the foregoing elements.

It should be noted that the controller 30 may control the foregoing elements through hardware and/or software. Thus, as the controller 30 may be described herein as performing various operations (e.g., searching, storing, generating, etc.), one of skill in the art would readily understand that the controller 30 may perform said operations through appropriate hardware and/or software mechanisms.

Similarly, one of skill in the art would further understand that all of the foregoing elements (i.e., the connection unit 10, the storage unit 20, as well as the controller 30 itself) could be realized through hardware and/or software implementations.

The contents playing apparatus 100 may exemplify all electronic devices which play contents. The contents playing apparatus 100 may display moving images or still images or play music files.

The external device 200 may include a storage medium such as a universal serial bus (USB) memory which stores contents therein. The external device 200 may include a camera which stores pictures therein, an MP3 player which stores music files, etc., therein. The external device 200 may further include a flash memory card which is used in electronic goods such as a digital camera, a hand-held camera, a mobile computer, a music player, a game console, etc. The flash memory card may include a personal computer memory card international association (PCMCIA) card, a compact flash card, a compact flash high-speed, a mini card, a smart media card, a memory stick, a secure digital (SD) card, an SD high-speed, a subscriber identification module (SIM) card, a smart card, a disk memory card, a flash internal semiconductor hard-drive (FISH) universal transportable memory card, etc.

The connection unit 10 is an interface through which the external device 200 is connected to the contents playing apparatus 100. The contents playing apparatus 100 communicates with the external device 200 through the connection unit 10 and receives contents stored in the external device 200. The connection unit 10 may include a wireless or wired interface for communication with the external device 200. For example, the connection unit 10 may support Bluetooth, infrared communication and wired or wireless USB communication.

The storage unit 20 stores therein input contents according to a control of the controller 30.

If it is determined that the external device 200 is connected to the contents playing apparatus 100 through the connection unit 10, the controller 30 automatically searches contents stored in the external device 200, and stores found contents in the storage unit 20. If the external device 200 is connected to the contents playing apparatus 100, the controller 30 automatically stores contents in the storage unit 20 without any manipulation or control of a user.

Typically, if an external device which stores contents therein is connected to a playing apparatus, a user should back up contents stored in the external device to the playing apparatus by downloading. To perform such an operation, the playing apparatus should include a user interface used to manipulate the operation. If the playing apparatus does not include such intermediate interface, a user should download the contents by using other media such as a computer.

The controller 30 according to the present exemplary embodiment minimizes these inconveniences for the user. The controller 30 may search for contents playable by the playing apparatus among contents stored in the external device 200 and store searched contents playable by the playing apparatus only or store all contents that may be played in other contents playing apparatuses. In the latter case, the controller 30 may store the contents by directory.

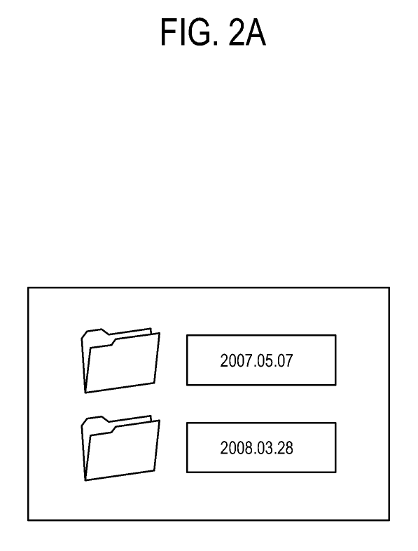

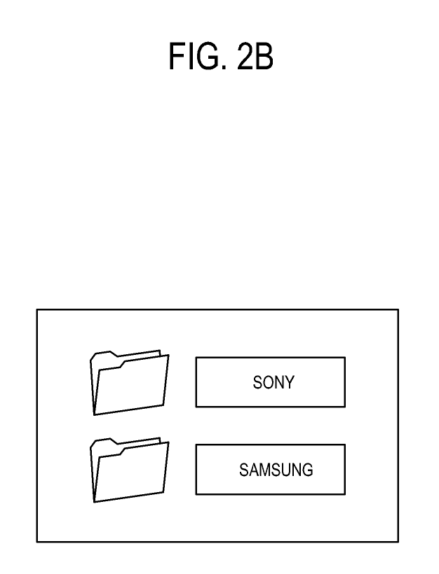

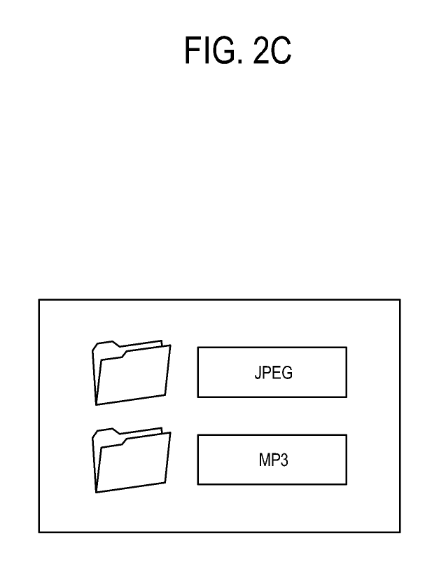

FIGS. 2A to 2C illustrate types of folders generated by a contents playing apparatus according to another exemplary embodiment of the present invention. Elements of the contents playing apparatus according to the present exemplary embodiment is substantially equivalent to those of the contents playing apparatus according to the exemplary embodiment previously described in FIG. 1. Thus, repetitive description will be avoided, and the present exemplary embodiment will be described with reference numerals in FIG. 1.

A controller 30 according to the present exemplary embodiment automatically generates a folder to store contents therein, and separately stores each of the contents in the generated folder if an external device 200 is connected to the controller 30. Each of the contents may be individually handled from the external device 200 to the storage unit 20 and stored therein by the controller 30.

FIG. 2A illustrates folders which are generated according to a generation date of contents, i.e., a date the contents are generated in the external device 200. The controller 30 sets the generation date of contents as a name of the folders. As shown therein, a first folder stores therein contents which are generated on May 5, 2007 while a second folder stores therein contents which are generated on Mar. 28, 2008. If the external device 200 includes a camera, for example, and the folders are generated as in FIG. 2A, a user may easily separate photo files by events when the photos are taken and play the photos in the order of time.

According to another exemplary embodiment, the controller 30 may generate folders by a storing date of contents, i.e. by a connection date of the external device 200, and may set the storing date of contents as the name of the folders. In addition, the controller 30 may assign the storing time of contents to the name of the folders or add numbers to the folders in the order of generating the folders if a plurality of external devices 200 is connected to the contents playing apparatus 100 and a plurality of folders is generated on the same date.

FIG. 2B illustrates folders which are generated by a manufacturer of an electronic device which generates contents and are named after the manufacturer. If the contents include images which are generated by a digital camera, for example, additional information about the image as well as the image is stored in the contents playing apparatus 100. The additional information may include an exchangeable image file format (EXIF). The EXIF is an image file format which is stored in an image file of a digital camera, and includes a manufacturer of the camera, a camera model, an image editor, an adjustment date of the image, a capturing date of the image, a size of the image, an exposure time, a focal length, etc.

The controller 30 generates a folder by using certain information of the additional information. FIG. 2B illustrates folders which are generated by the controller 30 by using information about camera manufacturers included in the EXIF, and store images (i.e., contents) according to a camera manufacturer. As the additional information may be changed or added by a predetermined application, a user may generate various folders by using desired additional information.

FIG. 2C illustrates folders which are generated by the controller 30 by a type of contents (e.g., text, image, video and sound data), and named after the type of contents. If different types of contents are stored in the external device 200, still images may be stored in a “JPEG” file and music files may be stored in an “MP3” file, separately.

As described above, the controller 30 may separate each of the contents according to various categories and store the contents by category. The controller 30 generates a name of a folder by using the category separating the contents so that a user may conveniently check the storage state of the contents. The method of separating and storing the contents or a type of generating the name of the folder is not limited to those described above, and may vary by a user.

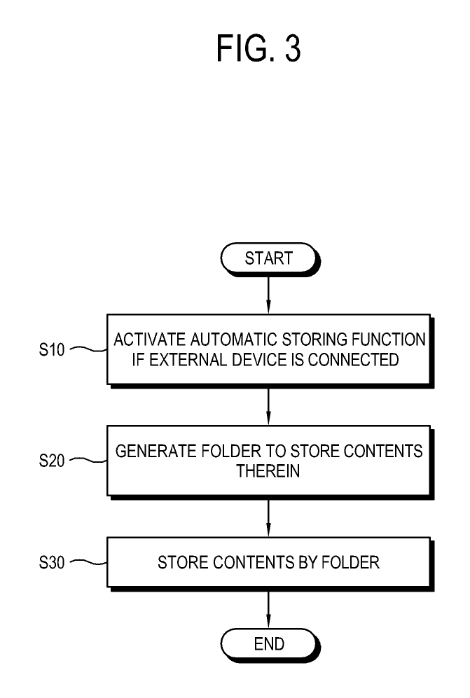

FIG. 3 is a control flowchart to describe a control method of the contents playing apparatus 100 according to the present exemplary embodiment. Hereinafter, the control method of the contents playing apparatus 100 according to the present exemplary embodiment will be described with reference to FIG. 3.

First, the controller 30 activates an automatic storing function to store contents if the external device 200 is detected by the controller 30 as being connected to the contents playing apparatus 100 (S10). The automatic storing function may be set as a default by a user. A user may disable the automatic storing function.

The controller 30 searches contents stored in the external device 200, and generates a folder by using additional information of the contents or according to a preset contents-separating method (S20). The folder may be generated by the generation date of contents, the connection date of the external device 200, the type of contents and the additional information stored together with the contents. The name of the folder is set according to the information used for generating the folder.

Then, the controller 30 stores the searched contents found in the external device 200 by the folder (S30).

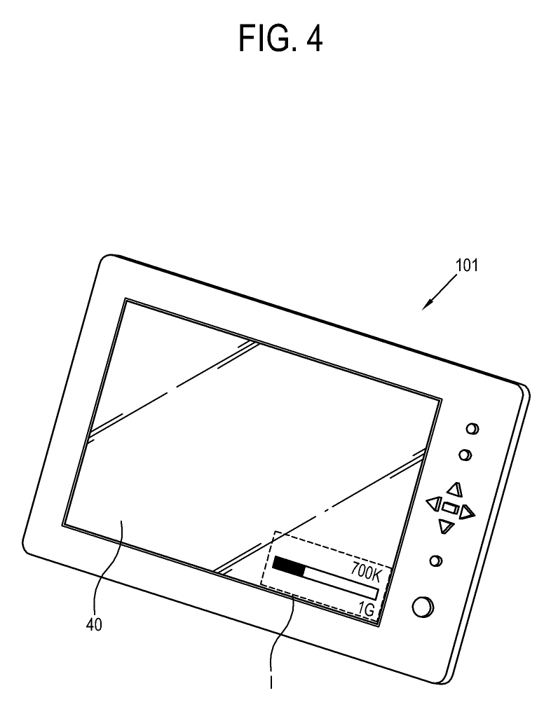

FIG. 4 illustrates a contents playing apparatus according to another exemplary embodiment of the present invention.

As shown therein, a contents playing apparatus 101 according to the present exemplary embodiment includes a display unit 40 which displays thereon a still image, such as a photo, or a moving image. The contents playing apparatus 101 may include a portable electronic device such as an electronic frame, a portable media player (PMP), etc. If the contents playing apparatus 101 includes the portable electronic device, the contents playing apparatus 101 further includes a display unit 40 which is smaller than a monitor or a TV.

If the contents to be stored include image data, the controller 30 adjusts a resolution of the contents based on a resolution of the display unit 40 and stores the contents whose resolution is adjusted. That is, a high resolution of image data is resized to a resolution that is supported by the display unit 40 such that the resolution of the image does not exceed the resolution of the display unit 40. The resolution adjustment is one of an image processing process accompanied when image data is displayed. If the resolution of the image data is adjusted when being stored, and not when being displayed, the size of the stored image is reduced and the storage unit 20 may be more effectively used. The method of adjusting the resolution of the image data may include various known methods, and not limited to a certain method.

After the contents are stored, the controller 30 provides information about a remaining capacity of the storage unit 20 to a user. Like capacity information I displayed on the display unit 40, the remaining capacity of the storage unit 20 is displayed in numbers, and a bar is also displayed to show the current contents storing capacity versus a total capacity of the storage unit 20. As the remaining capacity of the storage unit 20 is visualized, a user may easily manage the contents stored in the storage unit 20. The design of the capacity information I may not be limited to the bar and may be displayed in other forms. For example, the capacity information I may be displayed as a design which shows divided segments of the overall region like the divided circle.

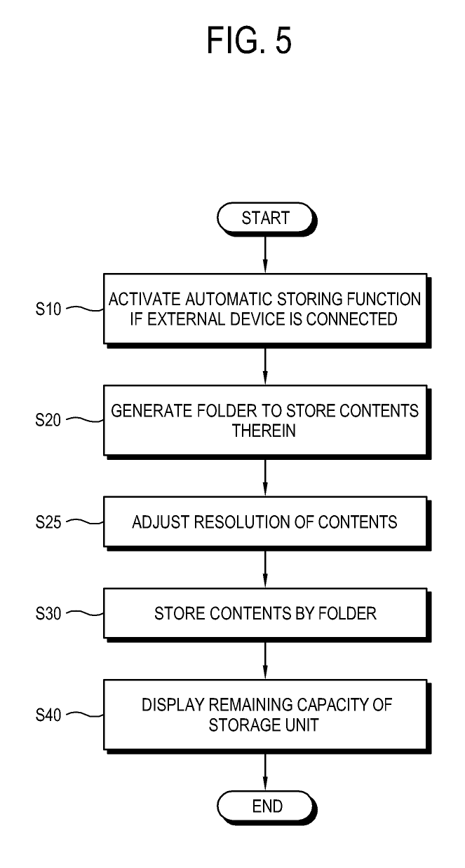

FIG. 5 is a control flowchart to describe a control method of the contents playing apparatus 101 in FIG. 4. The control method of the contents playing apparatus 101 according to the present exemplary embodiment is as follows.

If the external device 200 is connected to the contents playing apparatus 101 and the automatic storing function is activated (S10), the controller 30 generates a folder to store contents therein (S20).

If the contents include image data, the controller 30 adjusts the resolution of the contents based on the resolution of the display unit 40 (S25), and stores by folder the contents whose resolution is adjusted (S30).

After the contents are stored, the controller 30 displays the remaining capacity of the storage unit 20 (S40). The remaining capacity may be visualized as a bar showing the current contents storing capacity versus the total capacity, or displayed in numbers.

The present invention automatically stores contents in the contents playing apparatus if the external device 200 storing contents therein is connected to the contents playing apparatus, and a user may use the contents playing apparatus more conveniently.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A contents playing apparatus, comprising:
a connection unit to which an external device is connected;
a storage unit; and
a controller which, if the external device is connected through the connection unit, automatically searches for contents stored in the external device in a search, and stores contents found from the search in the storage unit.

2. The contents playing apparatus according to claim 1, wherein the controller generates at least one folder in the storage unit to store the found contents therein if the external device is connected.

3. The contents playing apparatus according to claim 2, wherein the controller generates each folder of the at least one folder according to a generation date of the found contents.

4. The contents playing apparatus according to claim 3, wherein the controller generates a name of each folder of the at least one folder with the generation date of the found contents stored therein.

5. The contents playing apparatus according to claim 2, wherein each folder of the at least one folder is generated by using additional information stored together with the found contents if the contents stored therein comprise image data.

6. The contents playing apparatus according to claim 5, wherein the controller generates a name of each folder of the at least one folder according to the additional information used for generating the folder.

7. The contents playing apparatus according to claim 2, wherein the controller generates each folder of the at least one folder according to a type of contents stored therein and generates a name of each folder of the at least one folder with the type of contents stored therein.

8. The contents playing apparatus according to claim 2, wherein the controller generates each folder of the at least one folder according to a storing date of the found contents stored therein.

9. The contents playing apparatus according to claim 8, wherein the controller generates a name of each folder of the at least one folder with a storing date of the found contents stored therein.

10. The contents playing apparatus according to claim 1, further comprising a display unit which displays an image thereon, wherein:
if the found contents comprise image data, the controller adjusts a resolution of the found contents based on a resolution of the display unit, and stores the found contents whose resolution is adjusted in the storage unit.

11. The contents playing apparatus according to claim 10, wherein the controller displays a remaining capacity of the storage unit on the display unit after the found contents are stored in the storage unit.

12. The contents playing apparatus according to claim 10, wherein the controller displays a current contents storage capacity versus a total capacity of the storage unit on the display unit after the found contents are stored in the storage unit.

13. A control method of a contents playing apparatus which includes a storage unit, the control method comprising:
automatically searching for contents which are stored in an external device in a search if the external device is connected to the contents playing apparatus; and
automatically storing the contents found in the search in the storage unit.

14. The control method according to claim 13, further comprising generating at least one folder to store the found contents in the storage unit.

15. The control method according to claim 14, wherein the generating the at least one folder comprises generating the at least one folder by at least one of a generation date of the found contents, a connection date of the external device, a type of the found contents, and additional information stored together with the found contents.

16. The control method according to claim 15, wherein the at least one of the generation date of the found contents, the connection date of the external device, the type of the found contents, and the additional information stored together with the found contents is used to generate a name of the at least one folder.

17. The control method according to claim 13, wherein the contents playing apparatus further comprises a display unit, and the method further comprises:
displaying the found contents on the display unit if the found contents comprise image data, and wherein the automatically storing the found contents comprises adjusting a resolution of the found contents based on a resolution of the display unit, and storing the found contents whose resolution is adjusted in the storage unit.

18. The control method according to claim 17, further comprising displaying a remaining capacity of the storage unit on the display unit after the found contents are stored in the storage unit.

19. The control method according to claim 17, further comprising displaying a current contents storage capacity versus a total capacity of the storage unit on the display unit after the found contents are stored in the storage unit.

20. An electronic frame which plays contents, the electronic frame comprising:
a display;
a connection unit to which an external device is connected;
a storage unit; and
a controller which, if the external device is connected through the connection unit, automatically searches for contents stored in the external device, stores the contents found from the search in the storage unit, and controls the display to display the contents found from the search and stored in the storage unit.
